(19) United States
(12) Patent Application Publication
(10) Pub. No.: US 2013/0054565 A1
(43) Pub. Date: Feb. 28, 2013

(54) IDENTIFICATION AND VERIFICATION IN COMMUNICATION SYSTEMS

(71) Applicants: Anne G. O'Connell, Cork (IE); Con D. Cremin, Cork (IE)

(72) Inventors: Anne G. O'Connell, Cork (IE); Con D. Cremin, Cork (IE)

(73) Assignee: Mingoa Limited, Cork (IE)

(21) Appl. No.: 13/696,115

(22) PCT Filed: May 4, 2010
(86) PCT No.: PCT/EP10/02713

§ 371 Date: Nov. 5, 2012

(51) Int. Cl. G06F 17/30

(52) U.S. Cl. 707/711; 707/E17.014

(57) ABSTRACT

Ethernet ‘operation, administration and management’ (OAM) circuits contain monitoring points that exchange ‘management” messages, particularly connectivity fault management messages and performance monitoring messages. This invention is a search process to identify a receiving monitoring point and also a further process to verify, particularly for continuity check messages, a management endpoint. The search processes use information carried in a message, in a hardware efficient method with predictable search times independent of search table size.

### FIELD OF THE INVENTION

This invention relates to performance measurements and to the detection of link connectivity in communication systems and particularly for Ethernet OAM circuits.

### BACKGROUND TO THE INVENTION

The standard specifications for operation of Ethernet OAM (Operation, Administration and Management) circuits, and particularly those conforming to IEEE 802.1ag and ITU-T Y.1731, include checks for connectivity and performance measurements between management points (MPs) in a management domain (MD). The management points comprise management endpoints (MEPs) and management intermediate points (MIPs). The management points exchange messages called ‘connectivity fault management’ (CFM) messages and ‘performance monitoring’ (PM) messages for these purposes. A subset of the CFM messages comprises ‘connectivity check’ (CCM) messages. These are employed such that management endpoints determine whether they have received a valid CCM within a prescribed time. The period, i.e. the interval between transmissions, can be configured, i.e. selected for each connection. A connectivity error is reported by an endpoint when a CCM has not been received from the end point's peer within a set multiple (presently 3.5) of the CCM transmission interval. Thus at the fastest CCM rate (3.3 ms) an error will be reported when a message from the peer is not received within 3.5×3.3=11.55 ms. Some CCM messages can carry counter values that are used to derive performance measurements at each MEP. These counter values represent numbers of transmitted and received packets within a given timer interval. Furthermore, specific PM messages can be exchanged to measure performance parameters such as frame loss, frame delay and variation in frame delay.

Such messages as indicated above are called herein generically ‘management messages’ which term is intended to embrace OAM messages and their equivalents.

A management point can ‘exist’ on a port of a network terminal. It can be used to monitor all connections from that port, or can be used to monitor selected service connections, those being identified by ‘service identifier’. This term is used herein to include an identification of a respective VLAN (virtual local area network). An MP can denote one of two directions. A ‘Down’ MP points towards the local area connection and away from the relay function of a switch or router, whereas an ‘Up’ MP points away from the local area connection towards the relay function of the switch or router. Lastly, there can be a number of operational levels at which an MP can operate (currently 8) and the operational level typically defines the range of the monitored connection, higher numbers indicating the longer ranges. A received CFM or PM packet therefore contains fields which are denoted herein the VLAN, DIRECTION and LEVEL fields. The corresponding port on which the packet is processed forms the ‘PORT’ field used in the identification process.

An MEP that transmits a CCM packet also includes a MEPID (MEP identification) field to identify the transmitting MEP at the receiving MEP. This MEPID must be configured in the receiving MEP. If it is not, an error is indicated.

Accordingly, all CFM messages need a lookup process in order to identify a management point to which they are addressed. Similarly, PM messages need a corresponding lookup process. CCM messages also need a further lookup stage to identify a peer MEP.

A network terminal (such as a switch or a router) can contain many management points, each monitoring different connections or services. Each CFM or PM packet contains fields that are used to select a management point. When such a CFM or PM packet is received at a network terminal containing management points, the management points to which it is addressed must be identified by means of a management point identification process. A management point can be identified by the combination of four fields, those being the port on which the management point exists, the VLAN or service identifier of the management point, the directional attribute of the management point (Up or Down) and the level of the management point (of which there are currently up to 8). One possible identification method is to form a lookup key by concatenating all 4 fields and using that key to address a table to read the result. While the identification process time will be short (only one read cycle), the required table for this method by necessity is very large (2^{N} where there are N address bits) but will typically be relatively sparsely populated. For received CCM packets, once the MEP is identified, a second process is required to verify that the peer MEP from which the packet was transmitted is configured in the receiving MEP. The standards allow for thousands of peer MEPs (currently 8K). Therefore a large, but typically sparsely populated, search table will be required if a similar lookup method is used.

All CFM messages need a lookup process in order to identify the management point to which they are addressed. Similarly, PM messages need a corresponding lookup process. CCM messages also need a further lookup stage to identify the peer MEP.

The present invention aims to reduce the table sizes required for both these processes while still keeping the lengths of the management point identification process and peer MEP verification process to small and predictable times independent of the table sizes.

The present invention is based on the combination of lookup mechanisms to maintain short search times and efficient table storage during the processing of management messages such as OAM messages and particularly CFM and PM packets. The invention may be implemented in hardware, no special software intervention being required.

### SUMMARY OF THE INVENTION

In one aspect the invention provides a search engine for the identification of a management point for a management message, the engine including a table containing entries indexed according to a service identifier and each containing a first address pointer and an identification of which ports out of a multiplicity of ports are associated with valid management points; and logic for generating addresses by a progressive incremental offset of an address indicated by the address pointer in accordance with an ordered count of the instances of the ports associated with the management points.

The search engine preferably further comprises a second table indexed by means of an address generated by said logic and containing entries each of which includes a second address pointer and an identification of the respective operational levels of management points existing on a respective port, and logic for generating secondary addresses by a progressive incremental offset of an address indicated by the second address pointer in accordance with an ordered count of the instances of operational levels.

The said identifications may comprise bit masks.

The search engine preferably further comprises a configuration table which contains entries each identifying a management point by service identifier, port and operational level, the configuration table being indexed by the secondary addresses.

Particularly for CCM messages, the search engine preferably further comprises stages for the validation of the identity of a peer management end point as stored in the configuration table.

These latter stages may perform a trie search.

In another aspect the invention provides a method of operation of a communication system, comprising of a multitude of management points that transmit and receive repetitive management messages on links between a management point and its peer management points of which there can be a minimum of one and a maximum imposed by the standards; and identifying a management point to which such a message is addressed and also (particularly for the CCM subset of CFM messages) the endpoint from which the message was transmitted, the method including storing entries indexed according to a service identifier in the message and each containing a first address pointer and an identification of which ports out of a multiplicity of ports are associated with valid management points generating first addresses by a progressive incremental offset of an address indicated by the address pointer in accordance with an ordered count of the instances of the ports associated with the management points; indexing, by means of the first addresses, a table containing entries each of which includes a second address pointer and an identification of the respective operational levels of the instances of management points existing on a respective port, generating secondary addresses by a progressive incremental offset of an address indicated by the second address pointer in accordance with an ordered count of the respective operational levels; and indexing by means of the secondary addresses a configuration table which contains entries each identifying management points by service identifier, port and operational level.

### BRIEF DESCRIPTION OF THE DRAWINGS

FIG. 1 is an explanatory diagram of a system employing management messages, particularly connectivity check messages.

FIG. 2 is a diagram illustrating a management point identification process according to the invention.

FIG. 3 is a diagram illustrating an example of the management point identification process according to the invention.

FIG. 4 is a diagram illustrating a peer MEP verification process according to the invention.

FIG. 5 is a diagram illustrating an example of the peer MEP verification process.

FIG. 6 illustrates a state machine.

### DETAILED DESCRIPTION

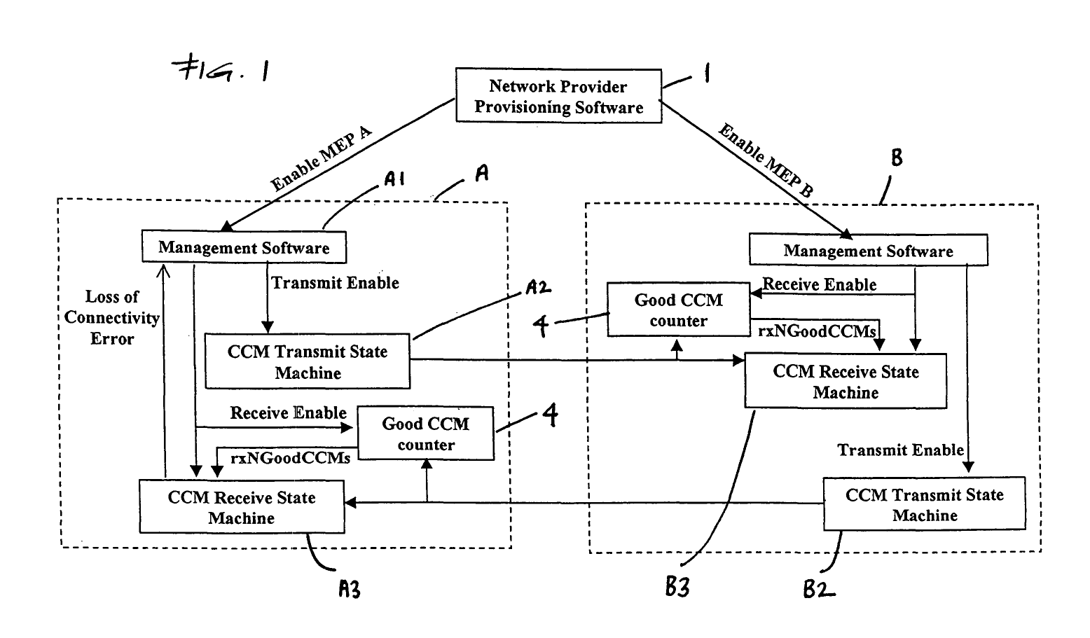

FIG. 1 illustrates a system in which OAM is employed to monitor a link between two peer management points A and B. It refers to CCM messages only for the sake of example. The management point A is shown by the chain-lines at the left and the management point B by the chain-lines at the right. A network provider (the provisioning software) programs management point A and B for an OAM connection with configuration data associated with each management point.

The configuration data includes a unique MEPID, a management point Level at which the CFM or PM messages operate, a VLAN identifier associated with the connection being monitored, a management point direction and the known peer management point. This data is associated with a port number on which the management point exists. Note that this diagram shows a point to point connection with a pair of management points, but this can be expanded to a system with up to 8K peer management points interconnected in a single monitored maintenance association.

Management point A is enabled by an appropriate message from the network provider 1. Its management software A1 immediately enables (in this example) a CCM transmit state machine A2 and a CCM receive state machine A3. The CCMs from the CCM transmit state machine A2 travel on the data channel to the CCM receive state machine B3 in management point B and the CCM state machine A3 is enabled to receive CCMs from the CCM state machine B2 in management point B.

Some time later, for example after an interval greater than 11.55 ms, the network provider 1 enables management point B and in particular the CCM receive and transmit state machines B3 and B2 in management point B.

FIG. 6 illustrates a receive state machine in conformity with IEEE 802.1ag and ITU Y.1731.

When the state machine is enabled it enters the IDLE state 30. This is formally denoted as the ‘RMEP_IDLE’ state; for simplicity herein the prefix RMEP (Remote Management End Point) will be omitted. After a delay (to be explained) machine enters the START state 31. In the START state a timer is started. This timer counts for the defined multiple (presently 3.5 times) of the selected CCM interval for the connection. If a valid CCM message is received within the timer's period, the state machine enters the OK state 32. The timer is re-loaded and the state machine again waits for the reception of a valid CCM daring the new period.

If a valid CCM is not received before the timer times out while the state machine is in either the START state or the OK state, the state machine enters the FAILED state 33 (hereinafter called the ‘third’ state) and raises an alarm. It remains in that state until receives a valid CCM is received.

Each of the management points A and B includes a counter 4 which when enabled loads a number N (which is adjustably selectable). The counter is decremented on each assertion of a valid received CCM (RxGoodCCM). Such a signal is necessary anyway to support the standard state machines and does not require any additional logic. If the counter counts N such signals, it provides an indication that N valid CCMs have been received.

In each instance the counter 4 is enabled by the respective management software. It receives CCMs from the link between the remote transmit state machine and the local receive state machine and it provides the indication ‘RxNGoodCCMs’ to the local receive state machine.

The operation of the counter 4 is indicated in the state machine of FIG. 6 by the WAITING state 34 (RMEP_INIT_WAIT). The machine does not initially transition from the IDLE state 31 to the START state 32. Instead, it enters the INIT-WAIT state 34 and remains there until the assertion of the indication that N valid CCMs have been received. Then the machine enters the START state 32 and the operation then proceeds as described with reference to FIG. 1.

In practice the management points A and B are separated by a network including devices such as switches and routers. At such a device it is necessary to perform a management point identification process.

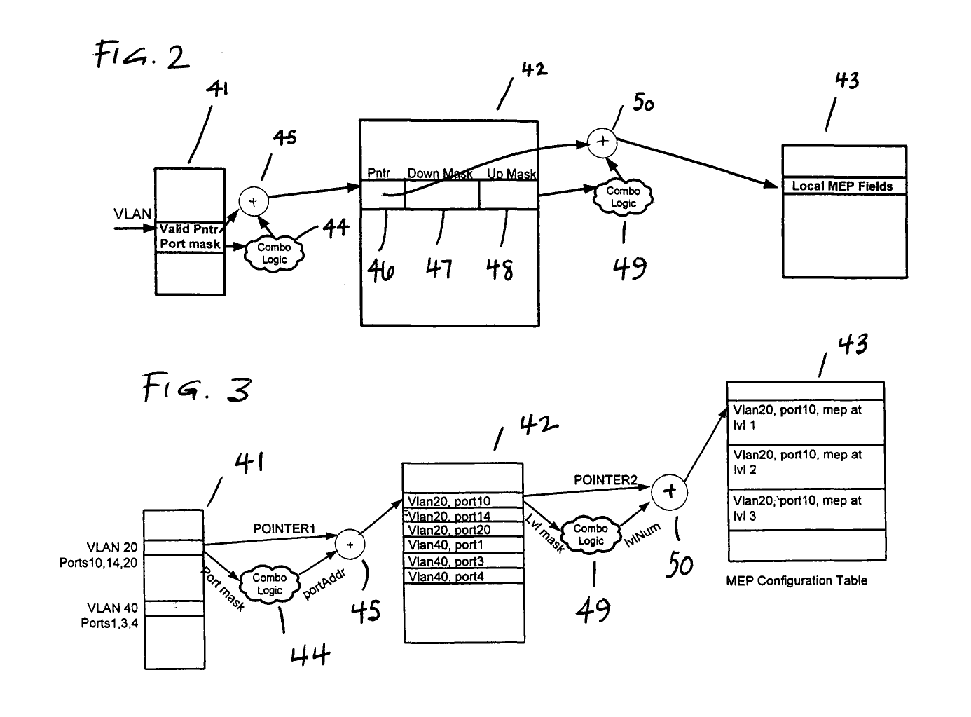

FIG. 2 illustrates schematically a search engine for use in such a device. It is preferably implemented in hardware and indeed it is an object of the invention to provide a search engine which is efficient in terms of hardware.

The management point identification process performed by the search engine consists of 2 lookup stages 41, 42 and a MEP Configuration Table 43.

The first lookup stage 41 uses the VLAN or other associated with the CFM or PM packet to read a table entry. The entry contains a validity bit (VALID), a pointer field (POINTER1) and an ordered port identification field (PORT MASK) which has a sub-field corresponding to each port. Preferably each such sub-field is a one-bit field, i.e. the PORT MASK is a ‘port bit mask’. The VALID bit is used to validate the entry. If the VALID bit is clear, then the whole entry for the VLAN is invalid and the management point search fails. Each location in the PORT MASK represents a port on which a management point can exist. For example, if the network terminal has 24 ports, then the PORT MASK will have 24 bits, one for each possible port. If a management point exists on a port for the said VLAN, the corresponding bit in the PORT MASK is set. If no management point exists on a port for the said VLAN, the corresponding bit in the PORT MASK is clear. When the entry is read, if the bit in the PORT MASK corresponding to the port is clear, the management point identification process fails. If it is set, then the address of the second stage lookup is calculated and the second stage lookup proceeds.

The address for the second stage lookup address is generated by means of a progressive incremental offset from a datum in accordance with an ordered count of the ports on which management point s exist. More particularly the port location in the PORT MASK is examined and its relative position relative to all other ports on which management point s exist (i.e. the bits that are SET in the PORT MASK) is generated by the logic 44. This generates an offset which is added (reference 45) to the datum address defined by the pointer POINTER1 to generate the required address.

The entries in table 42, which is read using the address generated from the first stage, each comprise a pointer 46 (POINTER2) to the MEP configuration table 23, and two ordered fields 47 and 48, one for each ‘direction’, indicating the operational level associated with the relevant management point. In this preferred example each field (denoted DOWN MASK and UP MASK) is an 8 deep bit mask, so that a first bit indicates level 0, a second bit indicates level 1 and so on.

The logic 49 computes for each port and for each management point which exist on that port a offset in accordance with an ordered count of the management point s which have operational levels in that port. In particular this count is, for each management point, the number of management points which have a lesser operational level in that port. This number is added (reference 50) as an offset to the pointer 46 to obtain an address in the configuration table 43.

This process may be explained with reference to FIG. 3 and two arbitrary examples, referring particularly to management end points (MEPs).

In a first example, for VLAN 20 there are 3 ports containing MEPs—ports 10, 14 and 20. Port 10 has a Down MEP at level 3, a Down MEP at level 2 and a Down MEP at level 1. Port 14 has a Down MEP at level 7 and a Down MEP at level 5. Port 20 has a Down MEP at level 4 and an Up MEP at level 5.

If the port on which the CFM or PM packet with VLAN 20 was processed was port 10, then its relative position in the PORT MASK is position 0, the count of ports being in this example being made starting at the lowest port number. If the port was port 14, then its relative position in the PORT MASK is position 1, there being one lower numbered port on which an MEP exists. If the port was port 20, then its relative position in the PORT MASK is position 2, because (for this service identifier) there are two lower numbered ports (ports 10 and 14) on which MEPs exist. Thus the relative positions of the ports can be represented by a progression of incremental values (0, 1, 2) in an ordered count of the ports on which MEPs exist. These values are not the port numbers but a count of the relevant ports. Each relative position is then added to the POINTER1 value to generate the address of the second stage lookup. Note that the POINTER1 value points to the start of a list of entries in the second table. The POINTER1 for VLAN 20 in this example has a value of 100. This means the list of entries for VLAN 20 that is stored in the second table starts at location 100. The first entry at location 100 is for VLAN 20 and port 10; the second entry, offset by 1 from the datum (100) is at location 101 is for VLAN 20 and port 14 and the third entry at location 102 is for VLAN 20 and port 20.

In a second example, there are 3 ports that have MEPs on VLAN 40—ports 1, 3 and 4. Port 1 has a Down MEP at level 7 and a Down MEP at level 0. Port 3 has a Down MEP at level 3. Port 4 has a Down MEP at level 5.

The POINTER1 value for this VLAN is configured as location 103, which means the list of entries for VLAN 40 that is stored in the second table starts at location 103—immediately after the list for VLAN 20. Thus the address for VLAN40 & port1=103, the address for VLAN40 & port3=104 and the address for VLAN40 & port4=105.

As indicated above, the table 42 is read using the address generated from the first stage 42. Each entry contains (as shown in FIG. 2) a pointer (POINTER2) to a MEP configuration table, an 8 deep UP MASK and an 8 deep DOWN MASK. The UP MASK contains 8 bits for any MEP with an UP DIRECTION and each bit corresponds to one of 8 possible MEP LEVELs. The DOWN MASK contains 8 bits for any MEP with a DOWN DIRECTION and each bit again corresponds to one of 8 possible MEP LEVELs. The DIRECTION and LEVEL are extracted from the received CFM or PM packet and are used to decode the contents the entry. If the received DIRECTION is UP, the bit in the UP BIT MASK corresponding to the received LEVEL is examined. If that bit is set, then the search is successful. If it is clear, the search is not successful. Similarly, if the received DIRECTION is DOWN, the bit in the DOWN BIT MASK corresponding to the received LEVEL is examined. If that bit is set, then the search is successful. If it is clear, the search is not successful. If the bit in BIT MASK is set, then its position relative to all other lower bits that are SET in the combined UP and DOWN BIT MASKs is used to generate the address of the MEP CONFIGURATION TABLE.

In the first example noted above, there are 3 DOWN MEPs for VLAN 20 on port 10 and no UP MEPs. These DOWN MEPs are at operational levels 3, 2 and 1. If the received LEVEL was 1, then its relative position in the combined UP and DOWN BIT MASK is position 0. If the received LEVEL was 2, then its relative position is position 1. If the received LEVEL was 3, then its relative position is position 2. The relative position is then added to the POINTER2 value to generate the address of the MEP CONFIGURATION TABLE. The POINTER2 for port 10 and VLAN 20 in this example has a value of 1000. This means the list of MEP CONFIGURATION entries for port 10 and VLAN 20 starts at location 1000. The first entry at location 1000 is for port 10, VLAN 20, DOWN MEP and level 1; the second entry at location 1001 is for port 10, VLAN 20, DOWN MEP and level 2 and the third entry at location 1002 is for port 10, VLAN 20, DOWN MEP and level 3.

In the second example noted above, for VLAN 20 on port 14 there are two DOWN MEPs at operational levels 7 and 5. The POINTER2 value for this VLAN 20/PORT 14 may therefore be configured as location 1003, which means the list of MEP CONFIGURATION entries starts at location 1003, i.e. immediately after the list for VLAN 20/PORT 10.

The search time for the management point Identification process is limited to 2 table reads. The memory storage required is a 4K deep first stage table (assuming a typical VLAN ID of 12 bits) together with a second table whose size is the number of MEPs supported. So for example if 1000 MEPs were supported, the size of the second table is 1000 entries and the combined size is a 5K entry. An alternative lookup scheme could be to form an address of the port, vlan, direction and level and use it to do a single table read. The size of that table however would be very large but only sparsely populated. For example, VLAN is typically 12 bits, the level is 3 bits, the direction is one bit and for a 24 port system, the port number is 5 bits. Combining these into one address results in a 21 bit address and the corresponding table size would be 2M entries but only sparsely populated with 1000 entries. The scheme according to this invention only requires a combined table size of 5K entries and a maximum of 2 table reads. Furthermore, the search time is predictable and independent of the sizes of the tables.

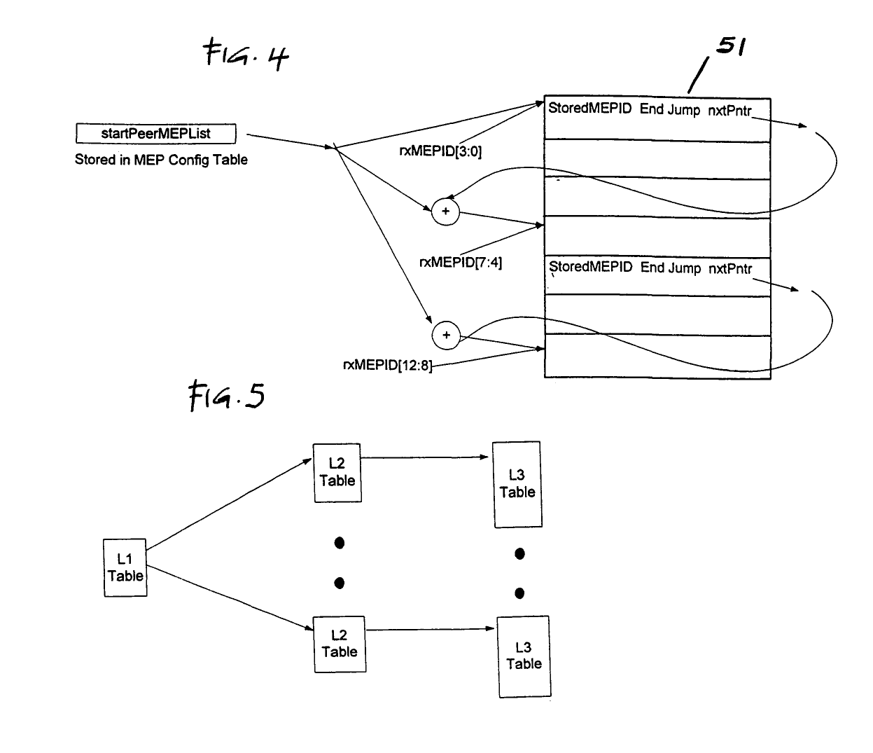

This invention also includes a search process for the list of configured peer MEPS in order to verify the transmitter MEPID. This search is required particularly for the CCM subset of CFM packets. The MEP Configuration Table 43 contains a start address to a stored list 51 (startPeerMEPList) of all peer MEPs associated with this MEP. This is searched using a method illustrated in FIG. 4. In this example, the maximum length of the search is three table reads. The first read uses the lowest significant bits (in this case four) of the received MEPID, i.e. rxMEPID{3:0}, to index into a table referred to as a L1 table. The results include a pointer (nxtPntr), and END bit, a JUMP bit and a STORED MEPID. If the END bit is set, the search is finished and the received MEPID is compared against the STORED MEPID. If they match, the search is successful. If the END bit is not set, and the JUMP bit is clear, the next group of bits of the received MEPID, in this case the next four bits rxMEPID[7:4], is used to read another table (referred to as an L2 table) starting at the location indicated by the nxtPntr and the process repeats there. If the END bit is not set, and the JUMP bit is set, the most significant bits rxMEPID[12:8] of the received MEPID (in this case the five most significant bits) are used to read a last table (referred to as an L3 table) starting at the NEXT POINTER location and the process repeats there. If the END bit is not set on the last search, or the received MEPID does not match the STORED MEPID, then the search fails. Otherwise, it is successful and the received MEPID is verified as being configured in the MEP.

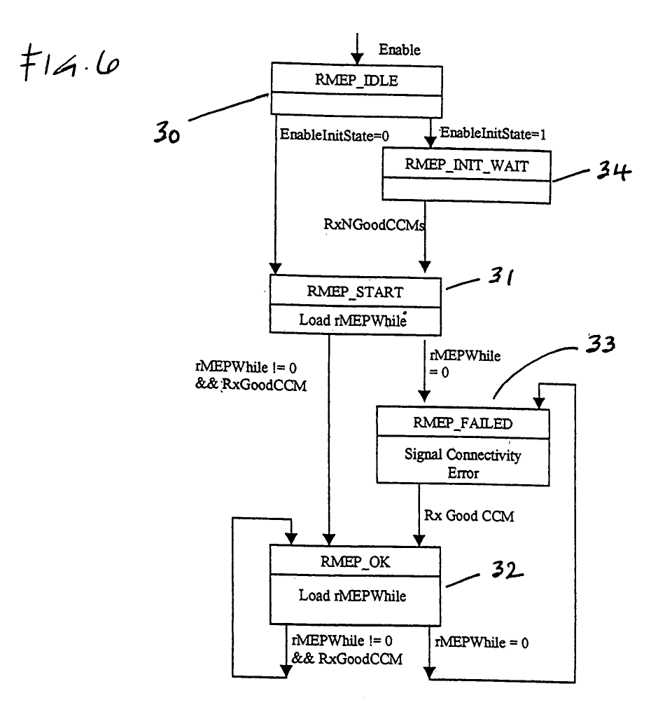

An example of this peer MEPID validation method is shown in FIG. 5. In this example, 100 MEPs are supported in the network terminal each of which is connected to 16 peer MEPs. In this example, the sizes of the L1 and L2 tables are 16 entries deep and the size of each L3 table is 32 entries deep. In the example, all of the possible 16 received MEPIDs map to 8 locations in the L1 table with a pair mapping to each location. For example, if two of the received MEPIDs were 0x0105 and 0x0005, then they would both map to location 5 in the L1 table. In this example, this situation is repeated on a further 7 locations in the L1 table. If the JUMP bit is not used, then 8 L2 table are required to do the second stage search. The second stage search for MEPIDs 0x0105 and 0x0005 will both map to location 0 in the L2 table. In this example, this situation is repeated on other 7 L2 tables. Eight L3 tables are required to resolve the search. MEPID 0x0105 maps to location 1 and MEPID 0x0005 maps to location 0 of the L3 table and the search ends by comparing the stored MEPID at these locations to the received MEPID. Note that if the JUMP bit were used, then the L2 search and its corresponding tables would not be required, improving the search time by 33% and the storage required by almost 33% in this example.

The search time for the peer MEP validation process in this example is limited to a maximum of 3 table reads. The memory storage for the example in FIG. 5 (without the use of the JUMP bit) is 1xL1+8xL2+8xL3 tables. In this example, L1=L2=0.5L3 so the storage required can be shown as 1xL1+8xL1+16xL1=25xL1. If 100 MEPs are supported, the total storage in this example is 2500xL1=2500×16 entries=40K entries. An alternative lookup scheme could be to form the address using the received MEPID of 13 bits and use it to do a single table read. The size of the table per MEP would be 8K and would be only sparsely populated with 100 entries. For 100 MEPs, the total storage required would by 800K entries. The scheme according to this invention only requires a combined table size of 40K entries and a maximum of 3 table reads for 13 bit received MEPID search key. Furthermore, the search time is predictable independent of the table sizes.

1. A search engine for the identification of a management point for a management message, the engine including:
a table (41) containing entries indexed according to a service identifier and each containing a first address pointer and an identification of which ports out of a multiplicity of ports are associated with valid management points; and
logic (44, 45) for generating addresses by a progressive incremental offset of an address indicated by the address pointer in accordance with an ordered count of the instances of ports associated with the management points.

2. A search engine according to claim 1 in which the said identification is a port bit mask.

3. A search engine according to claim 1 and further comprising a second table (42) indexed by means of an address generated by said logic (44, 45) and containing entries each of which includes a second address pointer and an identification of the respective operational levels of management points existing on a respective port, and logic (49, 50) for generating secondary addresses by a progressive incremental offset of an address indicated by the second address pointer in accordance with an ordered count of instances of operational levels.

4. A search engine according to claim 3 in which the said identification of the respective operational levels comprises at least one bit mask.

5. A search engine according to claim 3 in which in which the said identification of the respective operational levels comprises two bit masks, each indicating the instances of management point s having a respective directional attribute.

6. A search engine according to claim 3 and including a configuration table (43) which contains entries each identifying a management point by service identifier, port and operational level, the configuration table being indexed by the secondary addresses.

7. A search engine according to claim 6 and including stages for the validation of the identity of a management end point as stored in the configuration table.

8. A search engine according to claim 7 in which the stages perform a trie search.

9. A method of operation of a communication system in which a multitude of management points transmit and receive repetitive management messages on links between a management point and at least one peer management point, the method including identifying at least one management point on which such a message is addressed, the method including:
storing entries indexed according to a service identifier in the message and each containing a first address pointer and an identification of which ports out of a multiplicity of ports are associated with valid management points.
generating first addresses by a progressive incremental offset of an address indicated by an address pointer in accordance with an ordered count of the instances of the ports associated with the management points;
indexing, by means of the first addresses, a table containing entries each of which includes a second address pointer and an identification of the respective operational levels of the instances of management points existing on a respective port, generating secondary addresses by a progressive incremental offset of an address indicated by the second address pointer in accordance with an ordered count of the respective operational levels; and
indexing by means of the secondary addresses a configuration table which contains entries each identifying management points by service identifier, port and operational level.
